(19) United States
(12) Patent Application Publication
(10) Pub. No.: US 2011/0142231 A1
(43) Pub. Date: Jun. 16, 2011

(54) Prime number generating device, prime number generating method, and computer readable storage medium

(75) Inventor: Koichi Takeda, Saitama (JP)

(73) Assignee: OKI SEMICONDUCTOR CO., LTD., Tokyo (JP)

(21) Appl. No.: 12/926,775

(22) Filed: Dec. 8, 2010

(30) Foreign Application Priority Data
Dec. 11, 2009 (JP) 2009-281716

(51) Int. Cl. H04L 9/30

(52) U.S. Cl. 380/30

(57) ABSTRACT

A prime number generating device is provided that includes a computation unit capable of performing at least addition and division on data of a predetermined number of bits or less; a prime number candidate data generating unit that generates prime number candidate data with a larger number of bits than the predetermined number of bits; a partitioned prime number candidate data generating unit that generates a plurality of partitioned prime number candidate data elements by partitioning the prime number candidate data; and a determination data generating unit that generates determination data for determining whether or not the prime number candidate expressed by the prime number candidate data is a composite number by using the computation unit to add together the respective plurality of partitioned prime number candidate data elements.

### CROSS-REFERENCE TO RELATED APPLICATION

This application is based on and claims priority under 35 USC 119 from Japanese Patent Application No. 2009-281716 filed on Dec. 11, 2009, the disclosure of which is incorporated by reference herein.

### BACKGROUND

1. Technical Field

The present invention relates to a prime number generating device, a prime number generating method, and a computer readable storage medium, and in particular to a prime number generating device, a prime number generating method and a computer readable storage medium for generating a prime number employable in RSA encryption.

2. Related Art

Recently, along with developments in computer networks, such as the Internet, and with proliferation of mobile phones, there has been a rapid expansion in the exchange of digital data and in electronic purchase transactions. The importance of safe and secure transmission of data, and the importance of data security technology for data integrity and to authenticate data senders and data receivers is therefore increasing.

Currently, public key encryption technology is known as a technology for realizing such data security. In public key encryption, two types of key are prepared, a public key and a private key, with the public key being disclosed and the private key maintained secret. The public key is employed for encryption and authentication, and the private key is employed for decryption and signing. Although the public key and the private key are mutually related, an arrangement is adopted such that security is maintained even though the public key is disclosed by configuring such that the private key cannot be derived from the public key.

In RSA encryption methods typical of public key encryption, two large prime numbers are prepared, and their product is disclosed while these prime numbers themselves are kept secret. RSA encryption methods are based on the property that the prime factors are extremely difficult to derive even if their product is disclosed.

In order to generate the key for public key encryption, first large prime numbers must be prepared. Generally the following procedure is utilized in order to prepare the prime numbers.

First, an odd random number is generated by a random number generator, this being a possible prime number candidate. Next, primality testing is performed on this prime number candidate, and when determination is made that the prime number candidate is actually a composite number, a new prime number candidate is generated, and this is repeated until finally a prime number candidate is not determined to be a composite number. When determined not to be a composite number, this prime number candidate is output as a “prime number”.

The bit length of the data expressing the prime number for attempted generation is a large value expressed, for example, in 512 bits, 1024 bits or the like. The proportion of random numbers that are prime numbers at this order of magnitude is not high. The primality testing needs to be repeated from several tens of times to several hundreds of times until a prime number is found. Furthermore, since the computational amount for the processing of primality testing is itself large, a significantly long duration of processing is required for prime number generation.

The volume of computation in prime number testing is considerable in practice, whichever of a definitive primality test method or a probabilistic primality test method is employed.

Consequently, there is an idea to reduce the number of times the above primality testing is performed by subjecting the prime number candidates to pre-screening processing that uses comparatively lesser computational amount prior to performing such definitive primality testing or probabilistic primality testing.

For screening processing, there is a method in which the prime number candidate is divided by several small prime numbers prepared in advance and seeing whether or not the prime number candidate is exactly divisible thereby, and a method in which a product of all the above prime numbers are calculated in advance, and the greatest common devisor of a prime number candidate and the product is derived by employing an algorithm, such as a Euclidian algorithm method, and finding if the greatest common devisor is 1. These computations require computation of multi-precision arithmetic.

An encryption key is generated through such procedures. However, a method is described, for example in JP-A No. 2003-122251, in which an encryption key is generated by, after extracting a prime number candidate Px, performing screening processing computation and primality testing thereon, and after confirming the prime number candidate Px is a prime number, employing this value to generate an encryption key.

The generated encryption key is set in a device for use as a key for encryption, and actually employed as a cipher.

In cases such as the above where the device generating the encryption key is different from the device using the encryption key, for example where a PC generates an encryption key, and another device (referred to below as an encryption-key-using-device) uses the encryption key, the encryption key is externally transmitted in one form or another. There is consequently a risk of external leakage of the generated encryption key. Note that some examples given of encryption-key-using-devices include devices that perform encryption of data using an encryption key, such as, for example, an ID card, a payment device, or the like.

As a method for preventing leakage of the encryption key, consideration has been given to performing the encryption key generation within the encryption-key-using-device itself. By so doing, external leakage of the encryption key can be prevented since the generated encryption key is not externally transmitted.

However, while an encryption-key-using-device is installed with customized hardware for performing computations for encryption of data, customized hardware for generating an encryption key is not generally installed therein.

More specifically, since customized hardware for performing computations for data encryption is capable of executing modular exponentiation operation and/or modular multiplication operation, but cannot perform simple division or the like required for encryption key generation, when it is attempted to internally generate the encryption key within the device, such computations are therefore need to be performed by a Central Processor Unit (CPU) in the encryption-key-using-device.

Due to the bit length of the data for the encryption key and for computations for encryption key generation greatly exceeding the maximum bit length of the CPU, encryption key generation in the encryption-key-using-device requires a considerable amount of time.

### SUMMARY

The present invention provides a prime number generating device, a prime number generating method and a computer readable storage medium capable of efficiently generating a prime number employable in RSA encryption.

A prime number generating device according to a first aspect of the present invention is a prime number generating device including: a computation unit capable of performing at least addition and division on data of a predetermined number of bits or less; a prime number candidate data generating unit that generates prime number candidate data expressing a prime number candidate with a larger number of bits than the predetermined number of bits; a partitioned prime number candidate data generating unit that generates plural partitioned prime number candidate data elements by partitioning the prime number candidate data generated by the prime number candidate data generating unit to give data that is of the predetermined number of bits or less; a determination data generating unit that generates determination data for determining whether or not the prime number candidate expressed by the prime number candidate data is a composite number by using the computation unit to add together the respective plural partitioned prime number candidate data elements generated by the partitioned prime number candidate data generating unit; a prime number testing unit that primality tests the prime number candidate data in cases in which it is determined for at least one prime number that the prime number candidate is not a multiple of the at least one prime number by the computation unit dividing the at least one prime number into the determination data generated by the determination data generating unit; and an output unit that outputs the prime number candidate data as a prime number when the prime number candidate is determined to be a prime number by the prime number testing unit.

The computation unit here is capable of performing at least addition and division on the data of a predetermined number of bits m or less. The prime number candidate data generating unit generates prime number candidate data N expressing a prime number candidate of number of bits L that is greater than the predetermined number of bits m. The partitioned prime number candidate data generating unit generates plural partitioned prime number candidate data elements F (k) by partitioning the prime number candidate data N generated by the prime number candidate data generating unit into data (t bits) of the predetermined number of bits m or less. The determination data generating unit generates determination data S for determining whether or not the prime number candidate expressed by the prime number candidate data N is a composite number by using the computation unit to add together the respective plural partitioned prime number candidate data elements F (k) generated by the partitioned prime number candidate data generating unit. The prime number testing unit primality tests the prime number candidate data N in cases in which it is determined for at least one prime number that the prime number candidate is not a multiple of the at least one prime number by the computation unit dividing the at least one prime number into the determination data generated by the determination data generating unit. The output unit outputs the prime number candidate data N as a prime number when the prime number candidate is determined to be a prime number by the prime number testing unit. A prime number utilized in RSA encryption can thereby be efficiently generated.

The prime number generating device according to the first aspect of the present exemplary embodiment may be configured such that: the computation unit is further capable of at least one operation of modulo operation, shift operation and/or sign change operation; and the determination data generating unit generates the determination data by adding together respective data elements obtained by the computation unit using the one or more operations of modulo operation, shift operation, and/or sign change operation on the partitioned prime number candidate data elements.

A prime number generating method of a second aspect of the present invention is a prime number generating method in a prime number generating device including a computation unit capable of performing at least addition and division on data of a predetermined number of bits or less, the prime number generating method including: generating prime number candidate data expressing a prime number candidate with a larger number of bits than the predetermined number of bits; generating a plurality of partitioned prime number candidate data elements by partitioning the prime number candidate data to give data that is of the predetermined number of bits or less; generating determination data for determining whether or not the prime number candidate expressed by the prime number candidate data is a composite number by the computation unit adding together the respective plural partitioned prime number candidate data elements; primality testing the prime number candidate data in cases in which it is determined for at least one prime number that the prime number candidate is not a multiple of the at least one prime number by the computation unit dividing the at least one prime number into the determination data; and outputting the prime number candidate data as a prime number when the prime number candidate is determined to be a prime number.

The above prime number generating method obtains similar effects to those of the above prime number generating device by operation in a similar manner to the prime number generating device.

A computer readable storage medium according to a third aspect of the present invention is a computer readable storage medium stored with a program for executing prime number generation processing in a prime number generating device including a computation unit capable of performing at least addition and division on data of a predetermined number of bits or less, the prime number generating method including: generating prime number candidate data expressing a prime number candidate with a larger number of bits than the predetermined number of bits; generating plural partitioned prime number candidate data elements by partitioning the prime number candidate data to give data that is of the predetermined number of bits or less; generating determination data for determining whether or not the prime number candidate expressed by the prime number candidate data is a composite number by the computation unit adding together the respective plural partitioned prime number candidate data elements; primality testing the prime number candidate data in cases in which it is determined for at least one prime number that the prime number candidate is not a composite number having the at least one prime number as a factor by the computation unit dividing the at least one prime number into the determination data; and outputting the prime number candidate data as a prime number when the prime number candidate is determined to be a prime number.

The above computer readable storage medium obtains similar effects to those of the above prime number generating device by operation in a similar manner to the prime number generating device.

According to the present invention, a prime number generating device, a prime number generating method and a computer readable storage medium can be provided capable of efficiently generating a prime number employable in RSA encryption.

### BRIEF DESCRIPTION OF THE DRAWINGS

Exemplary embodiments of the present invention will be described in detail based on the following figures, wherein:

FIG. 1 is a diagram showing a hardware configuration of an IC card according to a present exemplary embodiment;

FIG. 2 is a diagram showing prime number candidate data and partitioned prime number candidate data;

FIG. 3 is a diagram showing schematic processing for performing prime number generation processing using partitioned prime number candidate data elements;

FIG. 4 is a schematic diagram showing correspondences employed in screening processing between partition candidate bit length, determination data, and prime numbers for dividing the determination data by;

FIG. 5 is a flow chart showing the flow of a prime number generation program; and

FIG. 6 is a flow chart showing the flow of screening processing.

### DETAILED DESCRIPTION

Detailed explanation follows regarding a best mode for implementing the present invention, with reference to the drawings. The present exemplary embodiment describes encryption key generation processing in RSA encryption. However, before embarking on such explanation, explanation follows of an example of a general encryption key generation procedure for operating RSA encryption.

First, a random number, such as one of 512 bits or 1024 bits, is generated using a random number generator. Such 512 bits, 1024 bits or the like are bit lengths that vastly exceed the bit length of current Central Processor Units (CPU). In the following explanation, a bit length that exceeds the bit length of a CPU, such as 512 bits, 1024 bits or the like, is referred to as an ultra bit length.

A primality test is performed on data of such ultra bit length. However, in this primality test, screening processing is performed prior to high processing load definitive or probabilistic primality testing. Specifically, this screening processing detects whether or not a generated random number is a multiple of a number of prime numbers (generally prime numbers of 3 digits or less, for example 3, 5, 7, 11 or the like) using a Euclidian algorithm or the like. Then, definitive or probabilistic primality testing is performed on data not determined by this screening processing to be a composite number. When determined to be a prime number, an encryption key is generated using this prime number. AKS primality test method is given as an example of a definitive primality test method, and a Fermat primality test and Miller-Rabin primality test are given as examples of a probabilistic primality test method.

The above screening processing is different to the main computation performed in definitive or probabilistic primality testing. Division is performed repeatedly in screening processing, whereas modular multiplication operation and modular exponentiation operation are performed in definitive primality testing and probabilistic primality testing. Specifically, a Euclidian algorithm generally used in screening processing is an algorithm in which the remainder from dividing a by b is denoted r, and the greatest common devisor of a and b is equivalent to the greatest common devisor of b and r. Therefore, the above division is performed repeatedly when executing this algorithm. Modular multiplication operation is computation to derive the remainder when the multiple of a and b is divided by m, and modular exponentiation operation is computation to derive the remainder when a to the power b is divided by m.

Each case involves computation being performed on data of ultra bit length, and modular multiplication operation and modular exponentiation operation are computations also performed when encrypting data. Hence, although a CPU such as that of a personal computer cannot be installed in some devices that perform encrypting (for example IC cards and payment terminals), custom chips are installed therein for performing modular multiplication operation or modular exponentiation operation.

Accordingly, an important issue with IC cards and payment terminals is how efficiently the above screening processing can be performed when generating encryption keys.

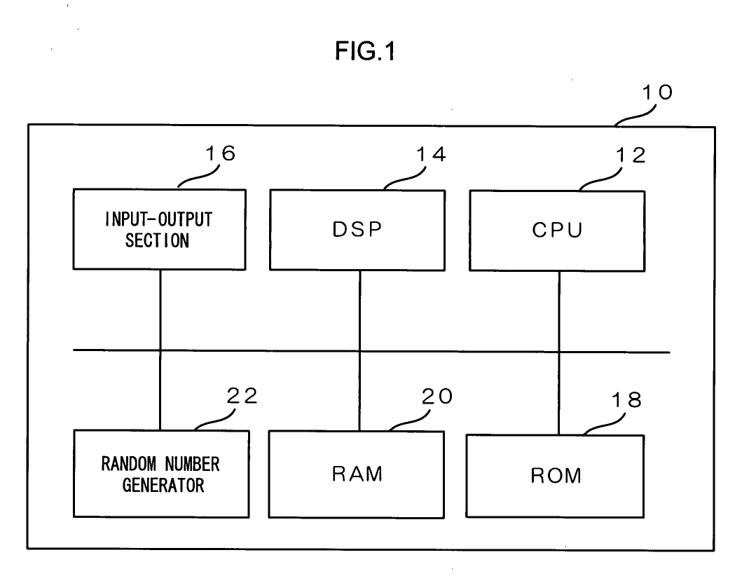

Now that the above explanation has been made, explanation follows regarding the present exemplary embodiment. FIG. 1 is a diagram showing a hardware configuration of an IC card employed in a prime number generating device of the present invention. However, there is no limitation thereto, and application can be made to any portable device in which encryption is performed, such as a payment terminal or the like. Application may also be made to a device configured with a Tamper Resistant Module (TRM) in which the inside of the chip is treated with a robust, highly adhesive coating, such that internal circuits are completely destroyed if the surface is peeled off.

As shown in FIG. 1, an IC card 101s configured include a CPU 12, a Digital Signal Processor (DSP) 14, an input-output section 16, Read Only Memory (ROM) 18, Random Access Memory (RAM) 20 and a random number generator 22.

The CPU 12 has capability to at least perform addition and division for data of a predetermined number of bits (denoted m bits in the present exemplary embodiment) or less. Furthermore, the CPU 12 may also have capability to perform one or more of the following operations: modulo operation, shift operation and/or sign change operation. Note that: modulo operation is an operation in which a is divided by b and remainder r is derived; shift operation is an operation that shifts a bit pattern of a binary number to the right or the left; sign change operation is an operation that derives −a from a. All of these operations are possible operations with a general CPU. Note that in the present exemplary embodiment, a capability for sign change operation indicates that subtraction can also be performed, by performing addition after sign change operation.

Furthermore, although there is a drop in processing speed, the CPU 12, serving as a computation unit, is capable of computation even for bit data having a greater number of bits than the predetermined number of bits, by, for example, partitioning the data into data of the predetermined number of bits or less and operating thereon.

The above m indicating the number of bits is generally an order of 2, such as 4, 8, 16 or the like. CPUs installed in the IC card 10 or the above payment terminal often have computation speeds that are significantly slower than that of CPUs installed in personal computers or the like.

The DSP 14 is a custom chip for performing the computations required when encrypting. Configuration is made such that, for example, data for encryption is output as encrypted data by setting an encryption key. The DSP 14 also has capability for modular multiplication operation and modular exponentiation operation on data of ultra bit length as required in encryption.

The input-output section 16 is one that performs wireless communication between the IC card 10 and another device. In particular, in the present exemplary embodiment, the input-output section 16 supplies electrical power for operating the IC card 10. Specifically, an antenna coil, condenser for accumulating electrical power and the like are incorporated in the input-output section 16, and electromotive force is induced by changes in the number of lines of magnetic flux passing through inside the antenna coil.

The ROM 18 is a non-volatile storage medium, such as flash memory or the like, and is stored with, for example, a program for performing prime number generation processing as shown in a flow chart, described below, and program(s) according to the IC card specification, and the like. The RAM 20 is a volatile storage device employed temporarily according to processing by each of the programs and the like.

The random number generator 22 generates an odd random number of ultra bit length as instructed by the CPU 12, and the generated random number is output to the RAM 20 and stored.

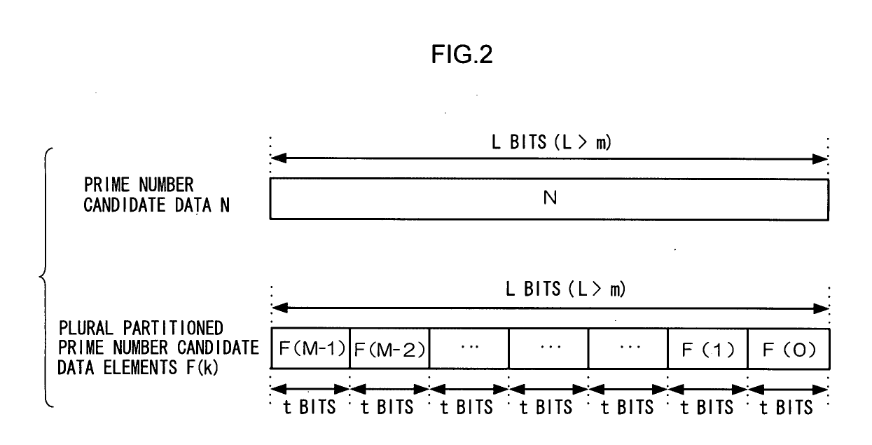

Next, explanation follows regarding the outline of prime number generation processing executed in the IC card 10, with reference to the drawings. FIG. 2 is shows the prime number candidate data N output to the RAM 20 and plural partitioned prime number candidate data elements F (k).

In the prime number generation processing of the present exemplary embodiment, the prime number candidate data N is the above data of ultra bit length (L bits) generated by the random number generator 22. The partitioned prime number candidate data elements F (k) is data of m bits, the bit length of the CPU, or lower that arises from partitioning the prime number candidate data N. In the case of FIG. 2, by partitioning the prime number candidate data N, t bits at a time (wherein t<m), the bit length of each respective F (k) is t bits. The plural partitioned prime number candidate data elements F (k) are configured, as shown in FIG. 2, by M (=L/t) individual data elements F (k) oft bits.

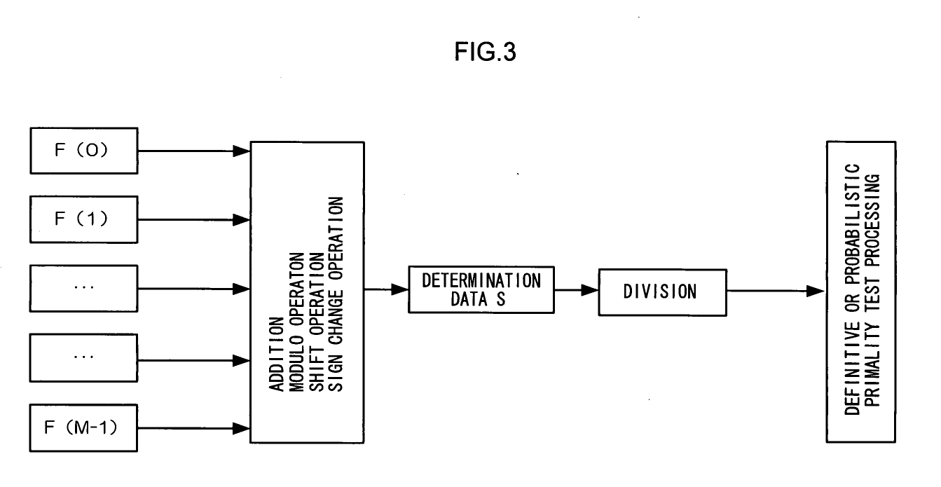

As shown in FIG. 3, in the prime number generation processing of the present exemplary embodiment, each of the respective plural partitioned prime number candidate data elements F (k) are added together by the CPU 12. Determination data S is thereby generated for determining whether or not the prime number candidate expressed by the prime number candidate data N is a composite number.

As long as the CPU 12 also capable of performing at least one of modulo operation, shift operation, and/or sign change operation, the determination data S is generated, as shown in FIG. 3, by adding together each data element obtained by performing one or more operations out of shift operation, modulo operation, and/or sign change operation on the plural partitioned prime number candidate data elements F (k).

When, by dividing the generated determination data S by one or more prime number(s) using the CPU 12, the prime number candidates are determined to not be a multiple of the at least one prime number, definitive or probabilistic primality testing is performed on the prime number candidate data N.

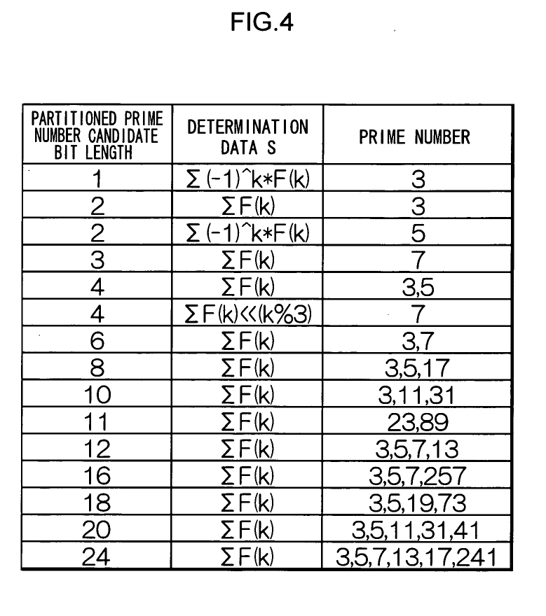

Next, explanation follows regarding the generation method of the above determination data S, with reference to FIG. 4. FIG. 4 is a schematic diagram showing data pre-stored on the ROM 18 and referenced by a prime number generation program. FIG. 4 shows correspondences between the partitioned candidate bit length employed in screening processing, the determination data S, and the prime numbers for dividing the determination data S by.

Specifically, for example, if the “partitioned prime number candidate bit length” is 1, then computation is performed according to the equation shown under “determination data S” then, as described below, the computation result is divided by 3.

The “partitioned prime number candidate bit length” in FIG. 4 corresponds to the above bit length t. In the “determination data S”, Σ means the sum from k=0 to M−1. The symbol “̂” means to the power of, the symbol “*” means product, the symbol “%” means modulo operation, and the symbol “<<” means left shift operation.

For example, S=Σ(−1)̂k*F(k) represents the following equation.

S=F(0)−F(1)+F(2)−F(3)+(−1)̂(M−1)*(M−1)

Namely, when the partitioned prime number candidate bit length is 2 and determination is being made as to whether or not it is a multiple of 3, as shown in FIG. 4, the prime number candidate data N is partitioned every single bit, and added and subtracted alternately in single bit units. With number of bits being assigned from the lowest position as the 0^{th} bit, the 1^{st} bit, the 3^{st} bit, the even numbered bits are added, and the odd numbered bits are subtracted. Determination is made as to whether or not the calculation result is exactly divisible by 3, and when exactly divisible, the prime number candidate data N is determined to be a multiple of 3, and when not exactly divisible, the prime number candidate data N is determined not to be a multiple of 3.

As shown in FIG. 4, two methods of deriving the determination data S exist when the partitioned prime number candidate bit length t is 2. In one of these methods, determination can be made as to whether or not prime number candidate data N is a multiple of 3, and in the other of these methods determination can be made as to whether the prime number candidate data N is a multiple of 5.

When the partitioned prime number candidate bit length t is 6, determination can be made as to whether the prime number candidate data N is a multiple of 3 or 7 using the determination data S. Namely, determination can be made as to whether or not the prime number candidate is a product of any one or more of plural prime number by derivation from a single determination data S.

In a more detailed explanation of an aspect of the contents shown in FIG. 4, when determining whether or not the prime number candidate data N is a multiple of 3, the prime number candidate data N is partitioned every 2 bits, and numbers of each F(k) looked at from 0 to 3, and summed. As long as the prime number candidate data N is of the order of about 1024 bits, the computation result can be contained within 32 bits. Consequently, determination is made as to whether or not the determination data S is exactly divisible by 3, and when it is exactly divisible the prime number candidate is determined to be a multiple of 3, and when not exactly divisible the prime number candidate is determined not to be a multiple of 3.

In order to determine whether or not the prime number candidate data N is a multiple of 5, the prime number candidate data N is partitioned every 2 bits, the numbers of each F(k) looked at from 0 to 3, and added and subtracted alternately. With number of bits being assigned from the lowest position as the 0^{th} bit, the 1^{st} bit, the 3^{rd} bit, the even numbered F(k) values are added, and the odd numbered F(k) values are subtracted. Determination is made as to whether or not the division result is exactly divisible by 5, and when exactly divisible, the prime number candidate data N is determined to be a multiple of 5, and when not exactly divisible, prime number candidate data N is determined not to be a multiple of 5.

In order to determine whether or not the prime number candidate data N is a multiple of 7, the prime number candidate data N is partitioned every 4 bits, and numbers of each F(k) looked at from 0 to 15, shifted and added. With number of bits are assigned from the lowest position of F(k) as the 0^{th} bit, the 1^{st} bit, the 2^{rd} bit, multiples of three numbered F(k) values are added without change, ((multiples of 3)+1) numbered F(k) values are left shifted 1 bit before adding, and ((multiples of 3)+2) numbered F(k) values are left shifted 2 bits before adding. Whether or not the determination data S is exactly divisible by 7 is determined, and when exactly divisible the prime number candidate data N is determined as being a multiple of 7, and when not exactly divisible, the prime number candidate data N is determined not to be a multiple of 7.

A method of determining whether or not a number is a multiple of a single prime number is given above, however a more detailed explanation follows of determination of whether or not a number is a product of any one or more of plural prime numbers, with reference to a portion of the contents of FIG. 4.

When identifying whether or not the prime number candidate data N is a multiple of 3 or 5, the prime number candidate data N is partitioned every 4 bits, the numbers of each of the F(k) are looked at from 0 to 15 and summed. Determination of whether or not the prime number candidate data N is exactly divisible by any one of 3 or 5 by considering whether the determination data S is exactly divisible by any one of 3 or 5.

When identifying whether or not the prime number candidate data N is a multiple of 3, 5, 7, 13, 17, or 241, the prime number candidate data N is partitioned every 24 bits, the numbers of each of the F(k) are looked at from 0 to 2̂24−1 and summed. Whether the prime number candidate data N is exactly divisible by any one or more of 3, 5, 7, 13, 17, or 241 or not is determined by considering whether the sum is exactly divisible by any one or more of 3, 5, 7, 13, 17, or 241.

In addition to these methods there are also several other methods for determining whether or not prime number candidate data N has a factor of certain small prime numbers while avoiding division of ultra bit length data and computation by Euclidian algorithm. Determination can be made as to whether the prime number candidate data N has any one or more plural prime numbers as a factor by appropriate combinations of such methods.

When the bit length L of the prime number candidate data N is not a multiple of the desired partition t, namely when L=qt+r (r≠0), in order to make it a multiple of t, (t−r) bits worth of 0's are added to the high end of the prime number candidate data N, the bit length L of the prime number candidate data N becomes L+t−r, and hence the bit length of the prime number candidate data N can be made a multiple of t.

In the schematic diagram shown in FIG. 4, there is no illustration regarding cases where the partitioned prime number candidate bit length is, for example, 5, 7, 9 or the like, however, a given partitioned prime number candidate bit length t can be selected by employing the following method.

For a given partitioned prime number candidate bit length t of m bits or less, first the prime factor p of (2̂t)−1 is derived, then S=ΣF(k) is derived (F (k) is t bits), and if p|S then p|N (N=prime number candidate data), and hence a given partitioned prime number candidate bit length can be selected. Note that a|b denotes that a is a factor of b.

As another method, for a given partitioned prime number candidate bit length t of m bits or less, first the prime factor p of (2̂t)+1 is derived, then S=Σ(−1)̂F(k) is derived (F (k) is t bits), and if p|S then p|N (N=prime number candidate data), and hence a given partitioned prime number candidate bit length can be selected.

There are various other methods other than the two methods above, however they are abbreviated here. For example, when t=5, (2̂t)−1=31, and since this is a prime number, determination can be made as to whether or not the prime number candidate data N is a multiple of 31. In such cases, determination can only be made for the single prime number 31, however from the perspective of increasing the efficiency of determination it is important to find values from as many different prime factors as possible. For example, when t=10, since (2̂t)−1=1023=3 *11 *31, determination can be made as to whether or not it is a multiple of any one or more of 3 prime numbers.

Furthermore, by utilizing partitioned prime number candidate data elements F (k) of m bits or less, the prime numbers for which it is possible to determine whether or not the prime number candidate data N is a multiple of a prime number are not limited to the prime numbers shown in FIG. 4. Even more efficient determination is possible by deciding on whether or not to perform determination using one or other of the determination data S shown in FIG. 4 according to the specification of the IC card 10.

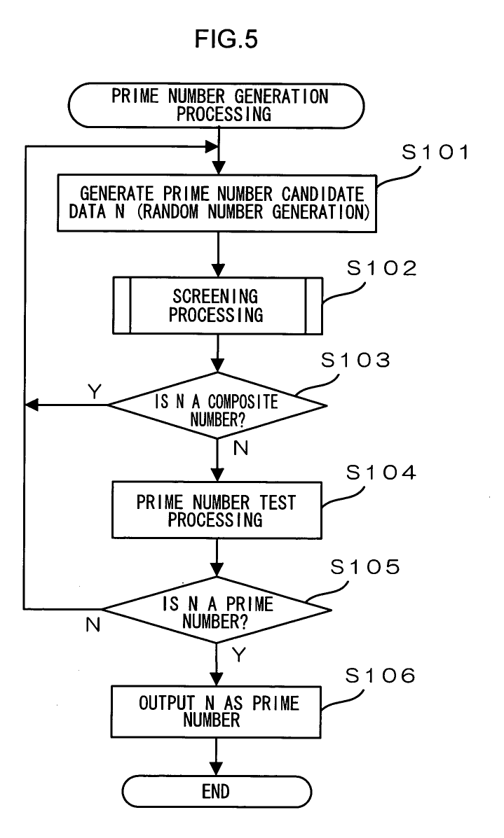

The above explained prime number generation processing using screening processing will now be explained with reference to a flow chart. FIG. 5 is a flow chart showing the flow of a prime number generating program executed by the CPU 12.

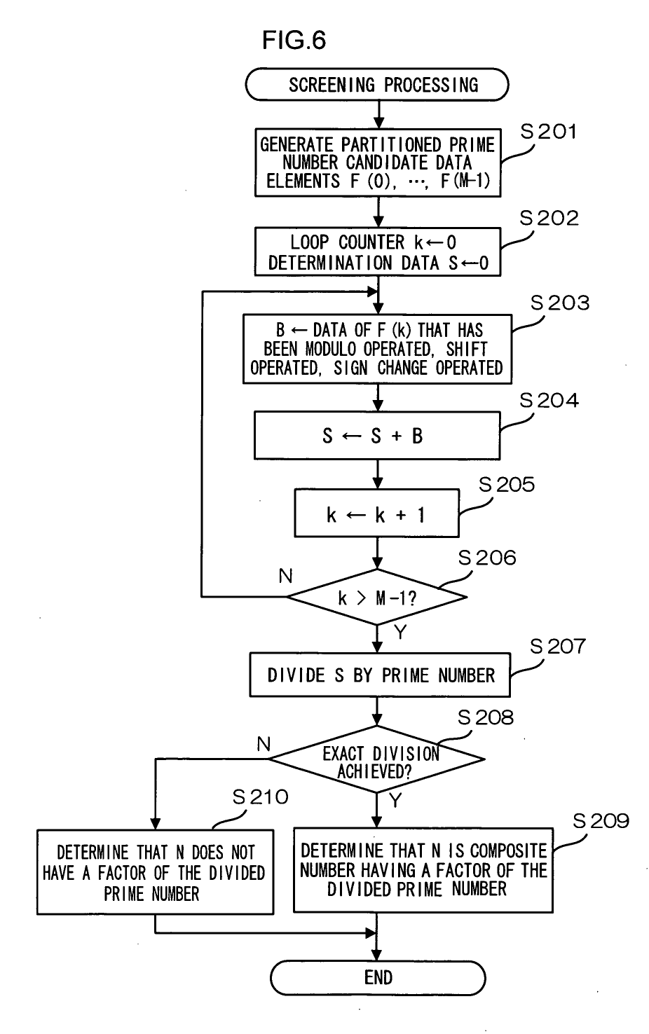

First, in step 101, prime number candidate data N is generated by the random number generator 22, expressing a prime number candidate of a greater number of bits than a predetermined number of bits (m bits in the present exemplary embodiment). The above screening processing is performed at the next step 102. Details of this screening processing are shown in FIG. 6.

At the next step 103, determination is made as to whether the prime number candidate data N is a composite number. The term composite number here refers to composite numbers having the prime numbers arising from modulo operation in the screening processing as factors, and does not include other composite numbers than these.

When affirmative determination is made at step 103, processing returns to step 101. However, when determination at step 103 is that the prime number candidate data N is not a composite number according to the above definition, definitive or probabilistic primality testing is performed at step 104. Namely, when determined that the prime number candidate is not a composite number having one or more of these prime numbers as factors, primality testing is carried out on the prime number candidate data N.

At the next step 105, determination is made by primality test processing as to whether or not the prime number candidate data N is a prime number. When negative determination is made at step 105, processing returns to step 101. However, when the prime number candidate data N is determined to be a prime number at step 105, the prime number candidate data N is output as a prime number at step 106, for example to the ROM 18, and processing is ended.

Note that when probabilistic primality testing is employed, the only results obtainable are “it is a composite number” or “indeterminable”. Accordingly, output at step 106 is that of a pseudo prime number. However, the precision of probabilistic primality testing can be raised, and, for example, one probabilistic primality test method called a Miller-Rabin primality test method can made a definitive primality test by testing over the entire appropriate range.

Next, explanation follows regarding the screening processing of above step 102, with reference to the flow chart of FIG. 6. First, at step 201, partitioned prime number candidate data elements F (0), . . . , to F (M−1) are generated (see FIG. 2). At the next step 202, a loop counter k and the determination data S are initialized to 0.

At the next step 203, modulo operated, shift operated and/or sign change operated data for element F (k) is substituted for variable B. Modulo operation (%), shift operation (<<), and sign change operation (−) is performed according to the schematic diagram shown in FIG. 4, however whether or not to perform determination with one or other of the determination data S out of the determination data S shown in the schematic diagram is decided in advance. In such cases, determination may be by a single determination data S, or may be determination by plural determination data S.

In the next step 204, the determination data S is refreshed with determination data S to which variable B has been added, and at step 205 the loop counter k is incremented by 1.

At the next step 206, determination is made as to whether or not the loop counter k is larger than M−1. This is a determination of whether or not processing has been completed for all F (k). When negative determination is made at step 206, processing returns to step 203, and when affirmative determination is made, the determination data S is divided by a prime number at step 207. The prime number(s) here is/are the prime number(s) shown in FIG. 4. Consequently, in the processing at step 207, division is performed by plural prime numbers when determination for plural prime numbers is possible.

At step 208, determination is made as to whether or not the determination data S is exactly divisible, namely determination is made for at least one prime number as to whether or not it is as a factor. When affirmative determination is made, determination at step 209 is that the prime number candidate data N is a composite number having the divided prime number as a factor, and when negative determination is made determination is that the prime number candidate data N does not have the divided prime number as a factor and processing is ended.

As explained above, in the present exemplary embodiment, due to screening processing being performed on data of the number of bits of the CPU 12 or less, screening processing can be performed with good efficiency. Accordingly, for example, even though an IC card or a payment terminal is a device that has comparatively low CPU processing power, there is capability to generate an encryption key within the device itself.

In such cases, as a result of being able to dispense with the transmission of an encryption key in one form or another from outside, as in conventional devices, leakage of the encryption key can be prevented.

The F (k) elements for deriving the determination data S are all elements of the CPU 12 number of bits or less. Accordingly, this enables computation that is significantly more efficient than computation on ultra bit length data. In addition, due to the computation employed when deriving the determination data S (addition, multiplication, shift operation and the like) being basic operations for which the CPU 12 has capability, the processing load can be reduced. Consequently, since power usage can be reduced, this screening processing is extremely compatible to portable devices.

Note that while an application example has been given of the IC card 10 in the present exemplary embodiment, since ultra bit lengths involved in RSA encryption are significantly greater than the CPU number of bits in personal computers, application may also be made to a personal computer.

The processing of the flow charts explained in FIG. 5 and FIG. 6 are only examples thereof, and the processing sequence can be changed, new steps can be added, and/or steps not required can be deleted, within a range not departing from the spirit of the present invention.

What is claimed is:

1. A prime number generating device comprising:
a computation unit adapted to performing at least addition and division on data of a predetermined number of bits or less;
a prime number candidate data generating unit that generates prime number candidate data expressing a prime number candidate with a larger number of bits than the predetermined number of bits;
a partitioned prime number candidate data generating unit that generates a plurality of partitioned prime number candidate data elements by partitioning the prime number candidate data generated by the prime number candidate data generating unit to give data that is of the predetermined number of bits or less;
a determination data generating unit that generates determination data for determining whether or not the prime number candidate expressed by the prime number candidate data is a composite number, by using the computation unit to add together the respective plurality of partitioned prime number candidate data elements generated by the partitioned prime number candidate data generating unit;
a prime number testing unit that performs primality testing on the prime number candidate data, in cases in which it is determined for at least one prime number that the prime number candidate is not a multiple of the at least one prime number, by the computation unit dividing the at least one prime number into the determination data generated by the determination data generating unit; and
an output unit that outputs the prime number candidate data as a prime number when the prime number candidate is determined to be a prime number by the prime number testing unit.

2. The prime number generating device of claim 1, wherein:
the computation unit is further adapted to at least one operation of modulo operation, shift operation or sign change operation; and
the determination data generating unit generates the determination data by adding together respective data elements obtained by the computation unit using the at least one operation of modulo operation, shift operation, or sign change operation on the partitioned prime number candidate data elements.

3. A prime number generating method in a prime number generating device comprising a computation unit adapted to performing at least addition and division on data of a predetermined number of bits or less, the prime number generating method comprising:
generating prime number candidate data expressing a prime number candidate with a larger number of bits than the predetermined number of bits;
generating a plurality of partitioned prime number candidate data elements by partitioning the prime number candidate data to give data that is of the predetermined number of bits or less;
generating determination data for determining whether or not the prime number candidate expressed by the prime number candidate data is a composite number by the computation unit adding together the respective plurality of partitioned prime number candidate data elements;
performing primality testing on the prime number candidate data, in cases in which it is determined for at least one prime number that the prime number candidate is not a multiple of the at least one prime number, by the computation unit dividing the at least one prime number into the determination data; and
outputting the prime number candidate data as a prime number when the prime number candidate is determined to be a prime number.

4. The prime number generating method of claim 3, wherein the
computation unit is further adapted to at least one operation of modulo operation, shift operation or sign change operation; and
determination data generating includes generating determination data by adding together respective data elements obtained by the computation unit using the at least one operation of modulo operation, shift operation, or sign change operation on the partitioned prime number candidate data elements.

5. A non-transitory computer readable storage medium storing a program for executing prime number generation processing in a prime number generating device comprising a computation unit capable of performing at least addition and division on data of a predetermined number of bits or less, the prime number generating method comprising:
generating prime number candidate data expressing a prime number candidate with a larger number of bits than the predetermined number of bits;
generating a plurality of partitioned prime number candidate data elements by partitioning the prime number candidate data to give data that is of the predetermined number of bits or less;
generating determination data for determining whether or not the prime number candidate expressed by the prime number candidate data is a composite number by the computation unit adding together the respective plurality of partitioned prime number candidate data elements;
performing primality testing on the prime number candidate data, in cases in which it is determined for at least one prime number that the prime number candidate is not a composite number having the at least one prime number as a factor, by the computation unit dividing the at least one prime number into the determination data; and
outputting the prime number candidate data as a prime number when the prime number candidate is determined to be a prime number.

6. The prime number generating method of claim 5, wherein the
computation unit is further capable of at least one operation of modulo operation, shift operation or sign change operation; and
determination data generating in the prime number generating processing includes generating determination data by adding together respective data elements obtained by the computation unit using the at least one operation of modulo operation, shift operation, or sign change operation on the partitioned prime number candidate data elements.
